(19) United States
(12) Patent Application Publication
(10) Pub. No.: US 2007/0281524 A1
(43) Pub. Date: Dec. 6, 2007

(54) Detachable USB card connector

(75) Inventor: Itzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd.

(21) Appl. No.: 11/785,303

(22) Filed: Apr. 17, 2007

Related U.S. Application Data
(60) Provisional application No. 60/803,508, filed on May 31, 2006.

(51) Int. Cl. H01R 13/62

(52) U.S. Cl. 439/159

(57) ABSTRACT

A card connector having a card attachment mechanism, a host attachment mechanism and electrical signal paths extending from the card attachment mechanism to the host attachment mechanism. The card attachment mechanism is reversibly attached to a card. The host attachment mechanism may be permanently attached to the card attachment mechanism and also reversibly attached to the host. The card attachment mechanism is configured to connect the electrical signal paths to electrical signal paths on the card, and the card connector is configured to transfer signals between the card and the host without changing the protocol of the signals. A card is configured for attachment with a connector to enable USB communication with a host.

### RELATED APPLICATIONS

This patent application claims priority under 35 U.S.C. §119(e) to U.S. Provisional Patent Application No. 60/803,508 filed May 31, 2006, which is hereby incorporated by reference in its entirety.

### FIELD OF THE INVENTION

The present invention relates generally to the field of USB card connectors.

### BACKGROUND OF THE INVENTION

A smart card including a processor and a storage device is typically used for financial transactions and for identification (ID). A smart card having a form factor, that is, a size and shape, of a typical credit card or personal ID is convenient to carry with other similarly sized cards.

One way for a smart card to communicate with a host is through a card reader, which is connected to the host. A typical card reader contains hardware to interface physically with the smart card. Also, because the protocol compatible with the host typically differs from the protocol of signals within the smart card, the card reader contains circuitry to convert signals flowing between the host to the smart card as required. Such a card reader is not transportable by the user as conveniently as the smart card.

Another way for a smart card to communicate with a host is by designing the smart card to include a USB connection. Walletex Microelectronics Ltd. of Rishon-Lezion, Israel marketed a USB flash drive with a body having a form factor that was similar to a credit card form factor. However, although the USB connector was smaller than the typical card reader discussed above, the USB connector caused the flash drive form factor to deviate significantly from a typical credit card form factor, and the USB connector was not removable from the flash drive to enable the flash drive to be conveniently carried with credit cards and personal identification.

US Patent Publication Application No. 2006/0273154 to Dan discloses a flash memory device having a form factor of a business card bearing printed information. The flash memory device also includes a non-volatile memory and electric signal paths for direct connection with a host. To enable such connection, the flash memory device has two slits extending a significant portion of the body's length, and a portion of the card is elastically bent out of the plane.

Although the flash memory device of Dan is designed to return to a form factor of a business card after detachment from a host, the bendable regions remain free to deviate from the business card form factor. Such freedom of deviation can be problematic at time, for example, when attempting to slide the flash memory device into a small compartment of a wallet intended for business cards.

Thus, it would be desirable to have a smart card and a connector such that the smart card maintains the form factor of an ordinary credit card, even when connected to a host, and the connector does not require bulky hardware to change the protocol of signals flowing to and from the host.

### SUMMARY OF THE INVENTION

The present invention may be embodied as a smart card and a card connector. The smart card maintains the form factor of an ordinary credit card, even when connected to a host. The connector does not require bulky hardware to change the protocol of signals flowing to and from the host.

The card may have an ID-1 format, that is, the card may have the physical dimensions (or “form factor”) of 85.60 mm×53.98 mm×0.76 mm (3.370 in×2.125 in×0.0299 in). Such form factor is commonly used for credit cards, debit cards, driving licenses, etc. The card may deviate from the stated dimension by perhaps as much as twenty percent, as long as the dimensions are substantially that of the ID-1 form factor. Besides the minor variations in length and width, the edges may have concave portion or other minor deviations. Nonetheless, the smart card can be conveniently carried with standard credit cards and personal identification, and the connector, due to the absence of bulky hardware associated with many prior art card readers, can also be conveniently carried and inexpensively produced.

The invention may also be embodied as a card connector that enables communication between a card and a host. The card connector has a card attachment mechanism reversibly attachable to a card, a host attachment mechanism attached to the card attachment mechanism and reversibly attachable to the host, and two electrical signal paths extending from the card attachment mechanism to the host attachment mechanism. The card attachment mechanism can connect the electrical signal paths to electrical signal paths on the card, and the card connector can transfer signals between the card and the host without changing the protocol of the signals.

The invention may further be embodied as a card assembly that communicates with a host. The card assembly has a card and a card connector. The card has electrical signal paths that are at least partially exposed. The card connector has a card attachment mechanism, a host attachment mechanism, and electrical signal paths. The card attachment mechanism reversibly attaches to the card. The host attachment mechanism is attached to the card attachment mechanism and is reversibly attachable to the host. The electrical signal paths extend from the card attachment mechanism to the host attachment mechanism. The card attachment mechanism is configured to connect the electrical signal paths of said card connector to the electrical signal paths on the card, and the card connector is configured to transfer signals between the card and the host without changing the protocol of the signals.

The invention may additionally be embodied as a card, which may be attached with a connector to enable USB communication with a host. The card has a body, logic circuitry, and electrical signal paths. The body conforms to an ID-1 form factor, and the logic circuitry is embedded within the body. The electrical signal paths extend from the logic circuitry, and at least a portion of the electrical signal paths are exposed to enable electrical contact with the connector while the body maintains the ID-1 form factor.

The invention may also be embodied as a method of communicating between a card and a host. The method includes: manually opening a card connector to create a gap; inserting a portion of the card into the gap; reversibly attaching the card connector to the card by connecting electrical signal paths of the card connector to electrical signal paths on the card; reversibly attaching the card connector to the host; and transferring signals between the card and the host without changing the protocol of the signals.

Additional features of the invention will become apparent from the following drawings and description.

### BRIEF DESCRIPTION OF THE DRAWINGS

For a better understanding of the invention with regard to the embodiments thereof, reference is made to the accompanying drawing, in which like numerals designate corresponding sections or elements throughout, and in which:

FIG. 1A illustrates a card assembly configured in accordance with a first embodiment of the present invention for communicating with a host;

FIG. 1B illustrates the card connector of FIG. 1A;

FIG. 1C is a top view of the card of FIG. 1A in accordance with the present invention;

FIG. 1D is a cross-sectional view of the card assembly of FIG. 1A;

FIG. 1E is a bottom view of the card assembly of FIG. 1A;

FIG. 2A illustrates a card assembly configured in accordance with a second embodiment of the present invention for communicating with a host; and

FIG. 2B illustrates the card connector of FIG. 2A.

### DETAILED DESCRIPTION OF THE INVENTION

The invention summarized above and defined by the claims below will be better understood by referring to the present detailed description of embodiments of the invention. This description is not intended to limit the scope of claims but instead to provide examples of the invention. The following discussion presents exemplary embodiments, which include a card assembly for communication with a host, a card connector for enabling communication between a card and a host, a card configured for attachment with a connector to enable USB communication with a host, and a method of communicating between a card and a host.

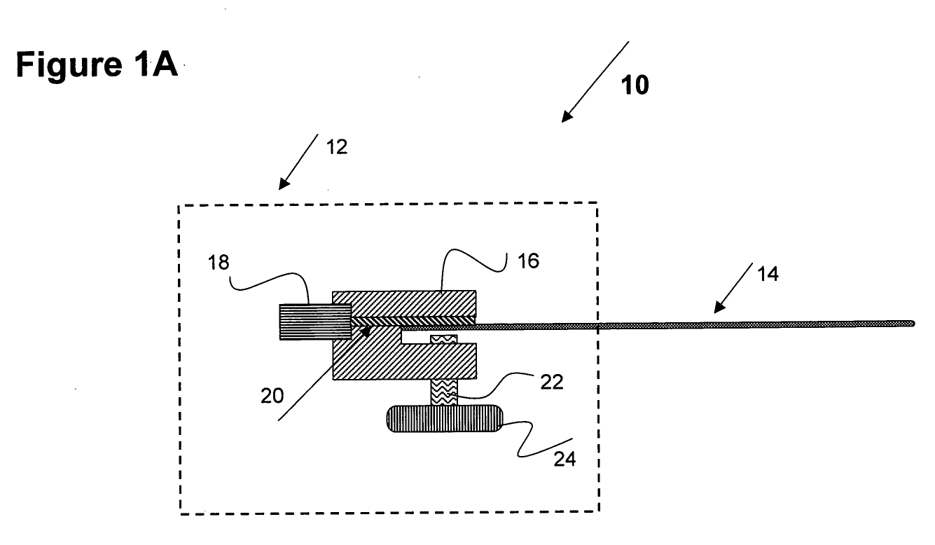

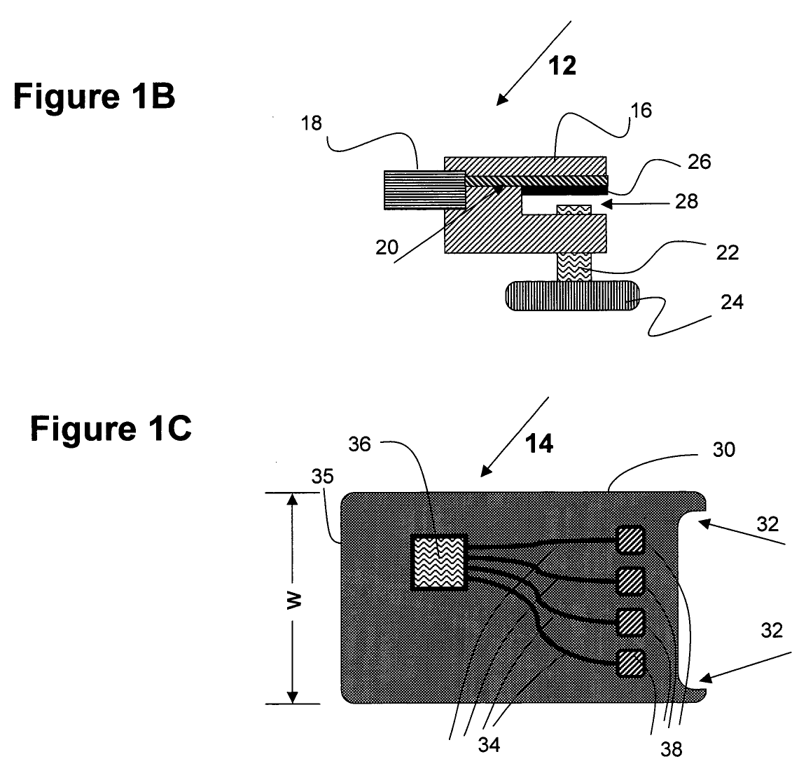

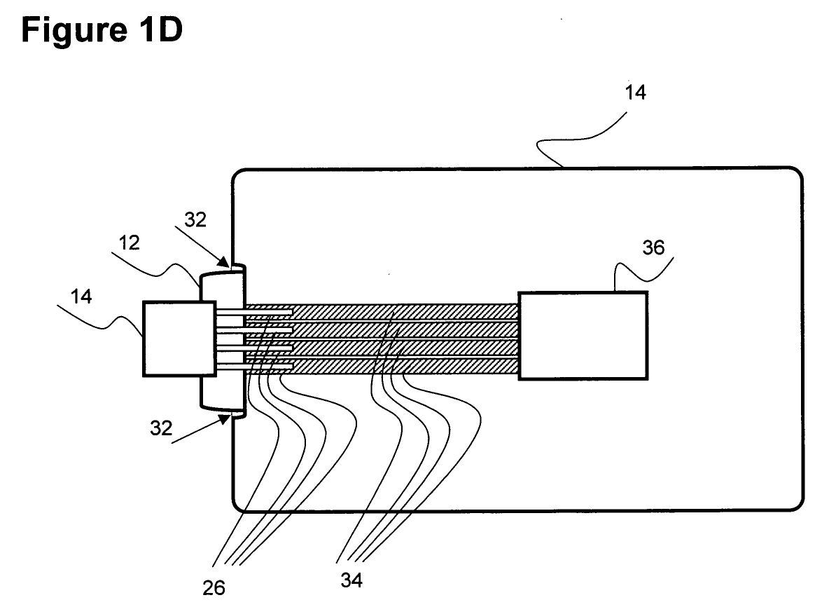

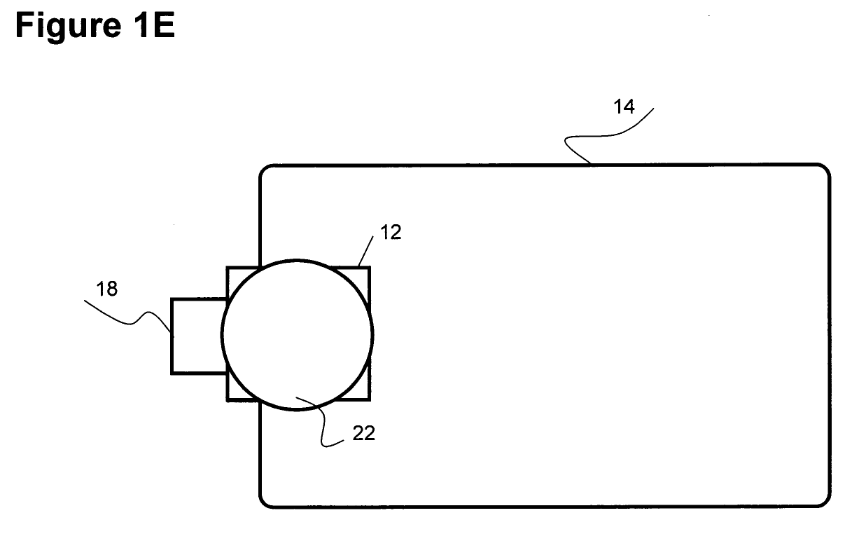

Referring to FIG. 1A, there is shown a card assembly 10 configured in accordance with a first embodiment of the present invention for communicating with a host. Card assembly 10 has a card connector 12 and a card 14. Card 14 is positioned within an aperture 28 (FIG. 1B) in the card connector 12, such that the electrical signal paths of the card 14 face upwards. Card 14 is described in more details in FIG. 1C.

Card connector 12 includes a card attachment mechanism 16, a host attachment mechanism 18, and at least two electrical signal paths 26 (FIG. 1B) extending from card attachment mechanism 16 to host attachment mechanism 18. Electrical signal paths 26 are located within the card connector 12 and are at least partially exposed to physically contact corresponding electrical signal paths of card 14. The electrical signal paths are part of a printed circuit board 20 and are not visible in FIG. 1A. Card attachment mechanism 16 is reversibly attachable to card 14 and permanently attached to host attachment mechanism 18.

Card attachment mechanism 16 may be sized to attach to an ID-1 format card. Note though, as is apparent in the drawings, that a card attachment mechanism sized accordingly is not necessarily unable to attach also to cards that are slightly thicker or slightly thinner than a common ID-1 format card. As is also clear from the drawings, a card attachment mechanism sized to attach to an ID-1 format card can easily attach also to cards of different lengths and widths.

Host attachment mechanism 18 is reversibly attachable to the host and may optionally include a USB connector. Host attachment mechanism 18 may be a plug or a socket. The card attachment mechanism 16 connects the electrical signal paths of the printed circuit board 20 to electrical signal paths on card 14, and thus card connector 12 is configured to transfer signals between card 14 and the host without changing the protocol of the signals.

In this embodiment, card attachment mechanism 16 has a clamp configuration, which includes a fastening screw 22 and a fastening knob 24 attached thereto. Manipulation of fastening knob 24 causes the fastening screw 22 to vertically shift within the card connector 12 and fasten the card connector 12 to card 14.

FIG. 1B provides a more detailed view of the card connector 12 of FIG. 1A. The visibility of electrical signal paths 26 was obscured in FIG. 1A due to the positioning of card 14 within aperture 28, but they are visible in FIG. 1B on the lower surface of printed circuit board 20. (Note that FIG. 1B is not to scale.) In this embodiment, electrical signal paths 26 are only exposed on printed circuit board 20 in the vicinity of aperture 28.

FIG. 1C shows a top view of the card of FIG. 1A. Card 14 has a width W parallel to an edge 35. (Due to the substantially rectangular shape of card 14, two opposing edges have the same width W. For clarity of illustration, though, only the edge 35 in FIG. 1C is labeled as having that width.) When the card attachment mechanism 16 attaches to the card 14 along the edge opposite edge 35, the width W of card 14 is greater than a parallel dimension of the card attachment mechanism 16. (See FIGS. 1D and 1E.)

Card 14 includes logic circuitry 36, electrical signal paths 34, and contact pads 38. Logic circuitry 36 is embedded within the body 30 of the card 14. The body 30 of the card 14 may have a smart card ID-1 form factor. The electrical signal paths 34 of card 14 extend from the logic circuitry 36 to the pads 38. The electrical signal paths 34 are exposed around the contact area of pads 38 to enable reliable electrical contact with the electrical signal paths of the card connector while the body 30 maintains its ID-1 form factor. That is, there is no need to cut/bend/fold the card 14.

For easily connecting the card connector to the card, the present embodiment does not require the elaborate alignment accessories often associated with smart card sockets, for example, a SIM card socket of a mobile telephone, where the small separation between the different contacts requires such assistance for the human operator. Instead, pads 38 can be arranged farther apart, for example, so that the separation between adjacent pads exceeds 0.4 mm apart. Such separation aids in the proper alignment of pads 38 with the card connector. Also, card 14 may also include an edge with a concave section 32 that is configured to guide the card connector to a fitting position on the card 14 when attaching the card connector to card 14.

FIG. 1D shows a cross-sectional view of the card assembly of FIG. 1A, where the electrical signal paths 26 extending from the card attachment mechanism 16 are mechanically and electrically connected to the corresponding electrical signal paths 34 on the attached card 14. Referring to FIG. 1E, there is shown a bottom view of the card assembly of FIG. 1A. Card 14 is fastened to card assembly 14 by fastening screw 22 (not visible) that is attached to the fastening knob 24.

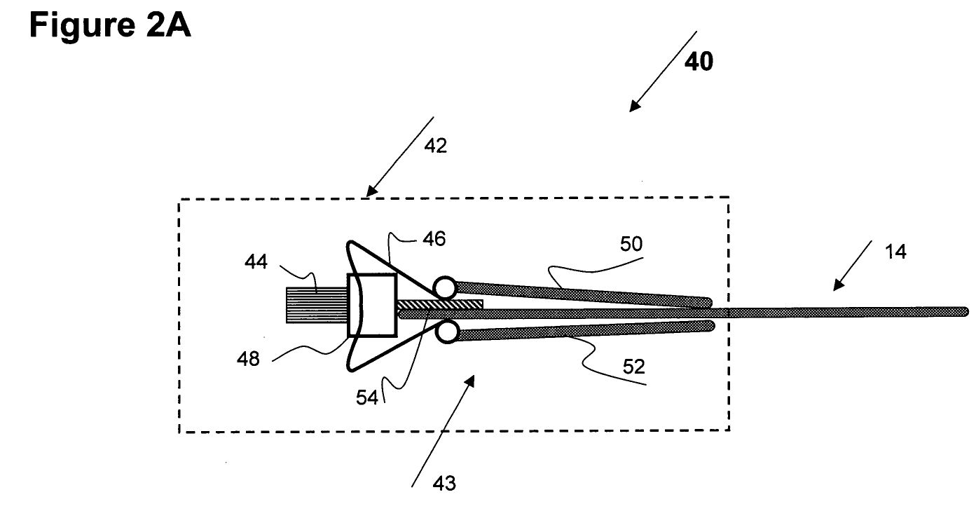

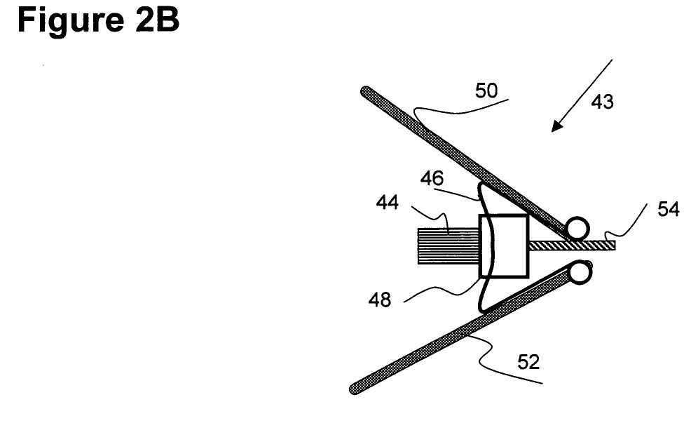

In a second embodiment of the present invention, with an analogous host attachment mechanism and electrical circuit paths, a card attachment mechanism has the clamp configuration of a binder clip. FIG. 2A shows a card assembly 40 having a card connector 42 and a card 14. Card connector 42 has a host attachment mechanism and electrical circuit paths that are analogous to those of card connector 10 of the first embodiment. Card connector 42 also has a card attachment mechanism 43, which is configured as a binder clip. Card 14 is positioned within an aperture 58 (FIG. 2B) in the card connector 42, such that the electrical signal paths 56 (FIG. 2B) of the card 14 face upwards.

The electrical signal paths 56 are located within the card connector 42 to fit corresponding electrical signal paths of card 14. In FIG. 2A, electrical signal paths are part of a printed circuit board 54 and thus are not visible. Card attachment mechanism 43 is permanently attached to host attachment mechanism 44 and reversibly attachable to card 14. The card attachment mechanism 43 can connect the electrical signal paths of the printed circuit board 54 to electrical signal paths on card 14, and thus card connector 12 is configured to transfer signals between card 14 and the host without changing the protocol of the signals.

In this embodiment, card attachment mechanism 43 has a binder clip configuration, which includes an elastic body 46 that may be a relatively strong steel spring 48 attached thereto. Body 46 is opened by compressing two arms 50 and 52 the body 46. Releasing two arms 50 and 52 when card 14 is positioned within aperture 58 allows the card connector 42 to grip the card 14 and thereby establish a strong electric contact between the electrical signal paths on the printed circuit board 54 and the corresponding electrical signal paths on the attached card 14.

FIG. 2B shows the card connector 42 of FIG. 2A without the card 14. The visibility of electrical signal paths 56 was obscured in FIG. 2A due to the positioning of card 14 within aperture 58, but they are visible in FIG. 2B on the lower surface of printed circuit board 54. (Note that FIG. 2B is not to scale). In this embodiment, electrical signal paths 56 are only exposed on printed circuit board 54 in the vicinity of aperture 58.

The present invention may also be embodied as a method of communicating between a card and a host. A user manually opens a card connector to create a gap (note, for example, aperture 28 in FIG. 1B) and then inserts a portion of the card therein. The method also includes reversibly clamping the card connector to the card and to the host and transferring signals between the card and the host without changing the protocol of the signals. The card connector is connected to the host by connecting at least two electrical signal paths of the card connector to electrical signal paths on the card. The card connector may be attached to the host either before or after being attached to the card.

The disclosure above discusses two different types of clamp configurations for a card attachment mechanism of a card connector. (Note, for example, the fastening screw/knob of FIG. 1B and the binder clip of FIG. 2B.) However, the invention is not limited accordingly. The card attachment mechanism of a card connector may alternatively be embodied with any other equivalent means for reversibly attaching to the card.

Also, the different types of host attachment mechanisms of a card connector disclosed above were those that might include a USB connector and might be a plug or a socket. However, the invention is not limited accordingly, and the host attachment mechanism of the card connector may alternatively be embodied as any other equivalent means for reversibly attaching to a host.

Additional variations of the host attachment mechanism fall within the scope of the invention. For example, host attachment mechanisms 18, 44 may be either reversibly or permanently attached to printed circuit board 26, 56, within card connector 12, 43, respectively. In one embodiment, a USB connector includes a plug body, which reversibly attaches to a printed circuit board, and electrical signal paths extending from the plug body. The electrical signal paths connect to electrical signal paths on the printed circuit board. In another embodiment, a USB connector includes a printed circuit board and two connector portions. The first connector portion is permanently attached to the printed circuit board, and the second connector portion is reversibly attachable to the first connector portion.

It should be noted that the card connector of the present invention typically functions as a USB connector. However, it can be understood that other implementations are possible within the scope of the invention, thus relating to a mechanical attachment mechanism that is attached to any type of one or more connectors in order to provide any multi-wire protocol communication between conductors of an attached card and the connector. As an example, the card connector of the present invention may function as a detachable USB connector for easily connecting a smart card of an ID-1 standard to a USB connector. Clearly, once the card connector of the present invention is attached to the smart card, the card connector may function as any ordinary Flash Drive device known in the art.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

1. A card connector for enabling communication between a host and a card, the card having a card width parallel to one edge, the card connector comprising:
(a) a card attachment mechanism operative to reversibly attach to the card along the one edge such that the card width is greater than a parallel dimension of the card attachment mechanism;
(b) a host attachment mechanism attached to said card attachment mechanism, said host attachment mechanism being operative to reversibly attach to the host; and
(c) at least two electrical signal paths extending from said card attachment mechanism to said host attachment mechanism.

2. The card connector of claim 1, wherein said card attachment mechanism is configured to connect said at least two electrical signal paths to electrical signal paths on the card, and the card connector is configured to transfer signals between the card and the host without changing the protocol of the signals.

3. The card connector of claim 1, wherein said host attachment mechanism includes a USB connector.

4. The card connector of claim 1, wherein said host attachment mechanism is a plug.

5. The card connector of claim 1, wherein said host attachment mechanism is a socket.

6. The card connector of claim 1, wherein said card attachment mechanism includes a clamp.

7. The card connector of claim 6, wherein said clamp is a binder clip.

8. The card connector of claim 6, wherein said clamp includes a fastening screw and a fastening knob attached thereto.

9. The card connector of claim 1, wherein said at least two electrical signal paths are part of a printed circuit board.

10. A card connector for enabling communication between a card and a host, the card connector comprising:
(a) a card attachment mechanism operative to reversibly attach to an ID-1 format card;
(b) a host attachment mechanism attached to said card attachment mechanism, said host attachment mechanism being operative to reversibly attach to the host; and
(c) at least two electrical signal paths extending from said card attachment mechanism to said host attachment mechanism,
wherein said card attachment mechanism is configured to connect said at least two electrical signal paths to electrical signal paths on the card, and the card connector is configured to transfer signals between the card and the host without changing the protocol of the signals.

11. A card connector for enabling communication between a card and a host, the card connector comprising:
(a) a first means for reversibly attaching to the card;
(b) a second means for reversibly attaching to the host, said second means being attached to said first means; and
(c) at least two electrical signal paths extending from said first means to said second means,
wherein the card connector is configured to transfer signals between the card and the host without changing the protocol of the signals.

12. A card assembly for communication with a host, the card assembly comprising:
(a) a card having electrical signal paths, said electrical signal paths being at least partially exposed, said card also having a card width parallel to one edge; and
(b) a card connector including:
(i) a card attachment mechanism operative to reversibly attach to said card along said one edge such that said card width is greater than a parallel dimension of the card attachment mechanism;
(ii) a host attachment mechanism attached to said card attachment mechanism, said host attachment mechanism being operative to reversibly attach to the host; and
(iii) at least two electrical signal paths extending from said card attachment mechanism to said host attachment mechanism.

13. The card assembly of claim 12, wherein said card attachment mechanism is configured to connect said at least two electrical signal paths of said card connector to said electrical signal paths on said card, and said card connector is configured to transfer signals between said card and the host without changing the protocol of the signals.

14. The card assembly of claim 12, wherein said host attachment mechanism includes a USB connector.

15. The card assembly of claim 12, wherein said host attachment mechanism is a plug.

16. The card assembly of claim 12, wherein said host attachment mechanism is a socket.

17. The card assembly of claim 12, wherein said card is a smart card.

18. The card assembly of claim 12, wherein said card includes an edge with a concave section.

19. The card assembly of claim 12, wherein said card attachment mechanism includes a clamp.

20. The card assembly of claim 19, wherein said clamp is a binder clip.

21. The card assembly of claim 19, wherein said clamp includes a fastening screw and a fastening knob attached thereto.

22. The card assembly of claim 12, wherein said at least two electrical signal paths are part of a printed circuit board.

23. A card assembly for communication with a host, the card assembly comprising:
(a) a card having electrical signal paths, said electrical signal paths being at least partially exposed; and
(b) a card connector including:
(i) a card attachment mechanism operative to reversibly attach to an ID-1 format card;
(ii) a host attachment mechanism attached to said card attachment mechanism, said host attachment mechanism being operative to reversibly attach to the host; and
(iii) at least two electrical signal paths extending from said card attachment mechanism to said host attachment mechanism,
wherein said card attachment mechanism is configured to connect said at least two electrical signal paths of said card connector to said electrical signal paths on said card, and said card connector is configured to transfer signals between said card and the host without changing the protocol of the signals.

24. A card assembly for communication with a host, the card assembly comprising:
(a) a card having electrical signal paths, said electrical signal paths being at least partially exposed; and
(b) a card connector including:
(i) a first means for reversibly attaching to said card;
(ii) a second means for reversibly attaching to the host, said second means being attached to said first means; and
(iii) at least two electrical signal paths extending from said first means to said second means,
wherein said card connector is configured to transfer signals between said card and the host without changing the protocol of the signals.

25. A card configured for attachment with a connector to enable USB communication with a host, the card comprising:
(a) a body conforming substantially to an ID-1 form factor;
(b) logic circuitry embedded within said body; and
(c) electrical signal paths extending from said logic circuitry, each of said electrical signal paths terminating at a contact pad, the separation between adjacent contact pads being at least 0.4 mm,
wherein said body is able to maintain the ID-1 form factor while the connector contacts said contact pads.

26. The card of claim 25, wherein said body has an edge with a concave section.

27. A USB connector connectable to a printed circuit board, the USB connector comprising:
(a) a plug body operative to reversibly attach to the printed circuit board; and
(b) electrical signal paths extending from said plug body, said electrical signal paths being connectable to electrical signal paths on the printed circuit board.

28. A USB connector comprising:
(a) a printed circuit board;
(b) a first connector portion being permanently attached to said printed circuit board; and
(c) a second connector portion operative to reversibly attach to said first connector portion.

29. A method of communicating between a card and a host, the method comprising:
(a) manually opening a card connector to create a gap;
(b) inserting a portion of the card into said gap;
(c) reversibly clamping said card connector to the card by connecting at least two electrical signal paths of said card connector to electrical signal paths on the card;
(d) reversibly attaching the card connector to the host; and
(e) transferring signals between the card and the host without changing the protocol of the signals.

30. The method of claim 29, wherein said reversibly attaching said card connector to the host is effected after said reversibly attaching said card connector to the card.

31. The method of claim 29, wherein said reversibly attaching said card connector to the host is effected before said reversibly attaching said card connector to the card.
